(19) United States
(12) Patent Application Publication
(10) Pub. No.: US 2022/0329450 A1
(43) Pub. Date: Oct. 13, 2022

(54) DEVICE WAKE-UP TECHNOLOGIES

(71) Applicant: Intel Corporation, Santa Clara, CA (US)

(72) Inventors: Harald SERVAT, Barcelona (ES); Amruta MISRA, Bangalore (IN); Mikko BYCKLING, Espoo (FI); Francesc GUIM BERNAT, Barcelona (ES); Jaime ARTEAGA MOLINA, Portland, OR (US); Karthik KUMAR, Chandler, AZ (US)

(21) Appl. No.: 17/852,174

(22) Filed: Jun. 28, 2022

(51) Int. Cl. H04L 12/12; H04L 67/1097; G06F 13/42; G06F 13/28

(52) U.S. Cl. CPC H04L 12/12; H04L 67/1097; G06F 13/4221; G06F 13/28; G06F 2213/0026

(57) ABSTRACT

Examples described herein relate to a network interface device that includes circuitry to perform switching and perform a received command in one or more packets while at least one of the at least one compute device is in a reduced power state, wherein the command is associated with operation of the at least one of the at least one compute device that is in a reduced power state. In some examples, the network interface device is able to control power available to at least one compute device.

### BACKGROUND

FIG. 1 depicts an example of data centers be composed by different platforms with different type of elements such as: (1) artificial intelligence (AI) inference engines; (2) field programmable gate arrays (FPGAs); (3) graphics processing units (GPUs); (4) infrastructure processing units (IPUs); (5) central processing units (CPUs); and so forth. High performance computing (HPC) and disaggregated infrastructures utilize multiple nodes with multiple components including multiple CPUs and accelerators. If a fraction of a system's hardware components is used while other hardware components are unused but powered on, the system's power envelope and energy consumption increases and can unnecessarily waste energy. Different devices may have different and independent power domains, with some of the devices powered-off to save energy.

Dynamic Voltage and/or Frequency Scaling (DVFS) and CPU package C-states are technologies to control power and energy consumption on processors and cores. DVFS dynamically adjusts voltage and the frequency of a CPU for power reduction. DFVS tunes frequency and voltage of dynamic and static power. CPU package C-states are core power states that can be specified by an Operating System (OS) power management infrastructure to define a degree to which the processor or the package is idle. However, a platform may be composed of many components such as XPUs, accelerators, storage, network, and memory, which can drain power and may not comply with configurations from DVFS and C-states.

Wake-on-LAN (WoL) is a standard (e.g., Energy Efficient Ethernet (EEE) IEEE 802.3az (2010)) that allows a powered-off or in a deep-sleep state computer with a powered-on network interface controller (NIC) device running in low-power (e.g., low-speed) mode. The computer can be turned on or awakened upon reception by the NIC of a particular formatted network packet called a Magic Packet.

### BRIEF DESCRIPTION OF THE DRAWINGS

FIG. 1 depicts an example of data centers be composed by different platforms with different type of elements.

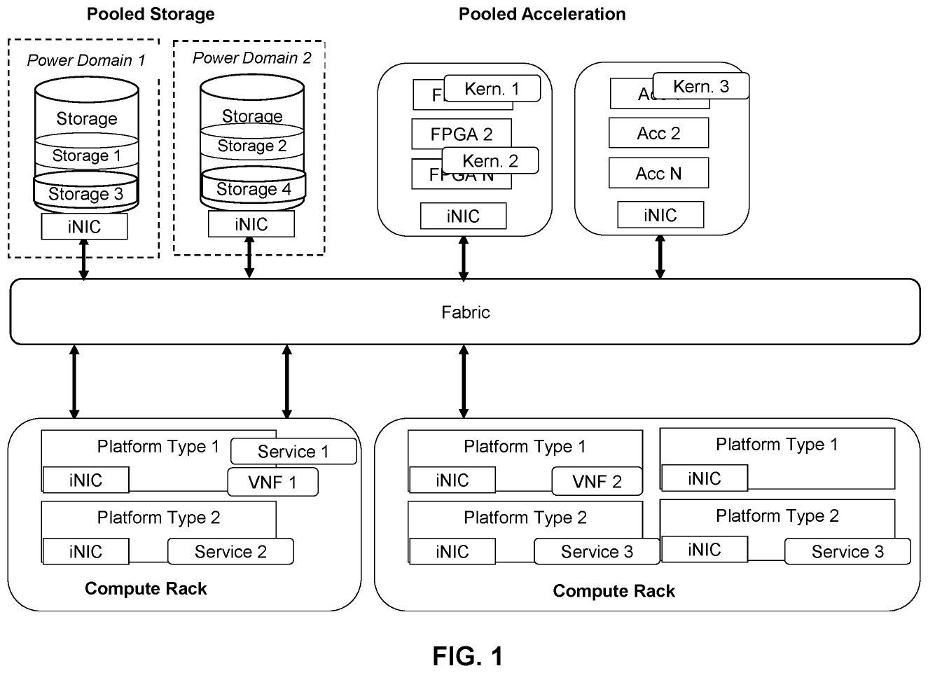

FIG. 2 depicts an example system.

FIG. 3 depicts an example system.

FIG. 4 depicts an example of operations for querying and/or discovering remote compute resources.

FIG. 5 depicts an example of operations for requesting a compute resource to execute a command.

FIG. 6 depicts an example of edge deployments.

FIG. 7 depicts an example process.

FIG. 8 depicts an example network interface device.

FIG. 9 depicts an example system.

FIG. 10 depicts an example system.

### DETAILED DESCRIPTION

At least to reduce power consumption in multi-device platforms, Wake on Compute (WoC) technology provides circuitry in a network interface device capable of responding to received instructions while allowing components or devices of the network interface device to be in a reduced power state. For example, the instructions can request device or hardware capabilities of the network interface device or device or hardware capabilities connected to the network interface device. For example, the instructions can request the network interface device to cause an instruction-specified device or hardware to perform a workload to process data or store or retrieve data. For example, the instructions can request the network interface device to cause an instruction-specified device or hardware to reduce power consumption or increase power consumption. Consequently, WoC technology provides energy savings and reduced operational costs, as well as a more flexible node power budget by powering off components to increase the power cap and potentially allow lengthier TurboBoost or boosted operations of the active components.

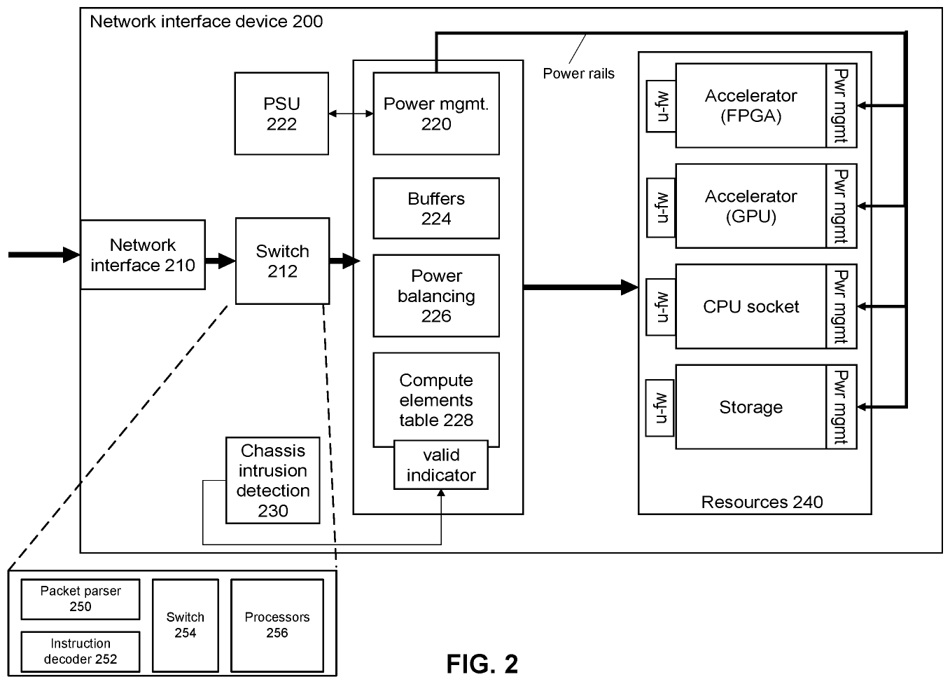

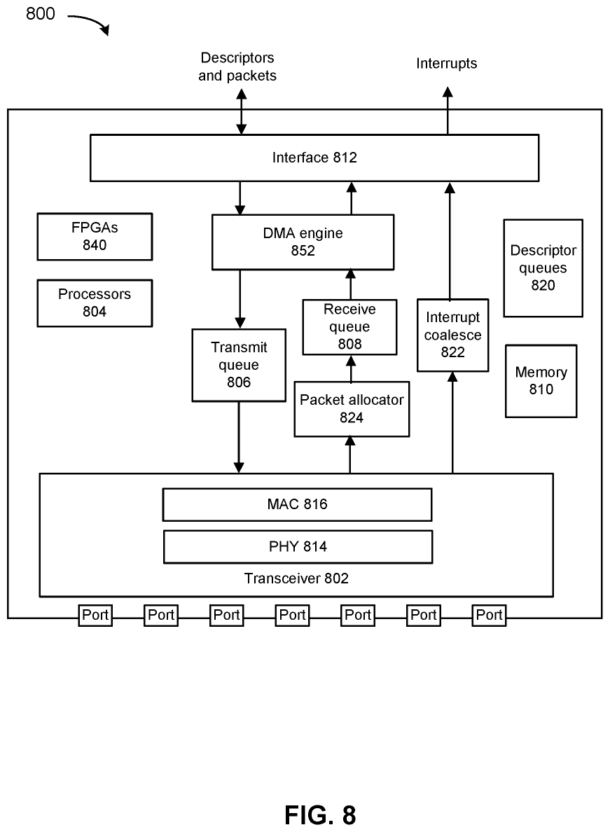

FIG. 2 depicts an example system. In some examples, parts of the system can be made available for use from a Cloud Service Provider (CSP) or a communication service provider (CoSP). Work and data can be submitted via one or more packets to a network interface 210 of network interface device 200. Various example of network interface 210 include physical layer interface (PHY), media access control (MAC) decoder and encoder, and other transceiver circuitry described at least with respect to the network interface of FIG. 8. Network interface 210 can provide content of received packets such as instructions provided in payloads of received packets to switch 212. Despite various circuitry of network interface device 200 being in a low power mode, switch 212 can include perform received instructions. Network interface 210, switch 212, one or more devices of resources 240, and other circuitry or devices of network interface device 200 could be powered-on or off using independent power rails. For example, devices of resources 240 can be placed in a reduced power state until at least switch 212 increases power available to one or more devices of resources 240. For example, resources 240 can include one or more accelerators, one or more graphics processing units (GPUs), one or more XPUs, one or more CPUs, one or more storage devices, one or more memory devices, and other circuitry.

Switch 212 can include programmable packet parser circuitry 250 to parse received packets provided by network interface 210 and identify instructions. In some examples, packet parser circuitry 250 can identify instructions received from one or more of: an application program interface (API), configuration file, packet payload, a WoL magic packet, or one or more header fields of one or more packets. Examples of instructions include commands to provide resource inventory of resources available for utilization by a requester, select one or more resources among resources 240 to perform a workload, increase power allocated to one or more resources among resources 240, decrease power allocated to one or more resources among resources 240, store or retrieve data, and others. In some examples, power can be increased by increasing voltage, current, or frequency. In some examples, power can be decreased by decreasing voltage, current, or frequency.

Packet parser 250 can be configured to execute instructions from approved sources based on packet header content, checksum value, certificate, among other manners of verifying an approved instruction. A source of a packet can be identified by a combination of tuples (e.g., Ethernet type field, source and/or destination IP address, source and/or destination User Datagram Protocol (UDP) ports, source/destination Transmission Control Protocol (TCP) ports, or any other header field). A packet may refer to various formatted collections of bits that may be sent across a network, such as Ethernet frames, Internet Protocols (IP) packets, TCP segments, UDP datagrams, etc.

Instruction decoder 252 of switch 212 can execute instructions from approved sources. Execution of a resource inventory instruction can cause switch 212 to access a compute element table from persistent memory to indicate hardware capabilities of resources 240. Capabilities of resources 240 can include one or more of: compression, decompression, encryption decryption, processor clock frequency, processor type (e.g., GPU, CPU, accelerator), device power utilization, device power cap, storage capacity, among others. Execution of workload instruction can cause switch to instruct power management circuitry to turns on one or more specific accelerators and can cause switch to provide data or commands to buffers. Workload instruction can be part of a service chain that use FPGAs in sequence. Workload instruction can include fields required by the function and Service Level Agreements (SLA) or Service Level Objective (SLO) for the request.

Switch 212 can include switching circuitry 254 to provide communication with devices such as power management (mgmt) 220, buffers 224, power balancing circuitry 226, and one or more devices of resources 240. In some examples, switching circuitry 254 can provide switching based on Peripheral Component Interconnect Express (PCIe), Compute Express Link (CXL), Universal Chiplet Interconnect Express (UCIe), or other connection technologies. See, for example, Peripheral Component Interconnect Express (PCIe) Base Specification 1.0 (2002), as well as earlier versions, later versions, and variations thereof. See, for example, Compute Express Link (CXL) Specification revision 2.0, version 0.7 (2019), as well as earlier versions, later versions, and variations thereof. See, for example, UCIe 1.0 Specification (2022), as well as earlier versions, later versions, and variations thereof. Switching circuitry 254 can access compute element table 228 stored in a memory device in connection with a performance of a resource inventory instruction, as described herein.

One or more circuitry of switch 212 (e.g., packet parser 250, instruction decoder 252, switching circuitry 254, or processors 256) can be powered by independent power-rails to receive and supply power from power supply unit (PSU) 222, so that circuitry can be independently powered on or off or receive reduced power. Similarly, other circuitry can be powered by independent power-rails to receive and supply power from PSU 222, such as power management 220, buffers 224, power balancing circuitry 226, or one or more devices of resources 240.

Processors 256 of switch 212 can execute instructions to track of how many compute resources are available in resources 240 and status including compute type, performance, whether resources are powered-on, maximum power drawn, and other aspects. For example, compute elements table 228 can include data to track at least how many compute resources are available in resources 240 and status including whether resources are powered-on, maximum power drawn, and other aspects. For keeping track of such data, compute elements table 228 can identify compute elements, power consumptions, and whether they are powered-on, such as shown in Table 1.

TABLE 1

| | | | Power | | | |
|---|---|---|---|---|---|---|
| Table | | Peak | Consumption | Mem | | Quality of service |
| Entry # | Type | Performance | Nominal/Peak | Capacity | Powered-on? | (QoS) |
| 0 | CPU | 1 TFLOP/s | 120/150 W | 16 GB | Yes | 1/Boot-time |
| | | | | | | latency |
| | | | | | | 2/Performance on |
| | | | | | | SinglePrecision/ |
| | | | | | | DoublePrecision |
| | | | | | | 3/Memory |
| | | | | | | Bandwidth 4/ |
| | | | | | | Shareable |
| 1 | CPU | 1 TFLOP/s | 120/150 W | 16 GB | No | Idem |
| 2 | CPU | 1 TFLOP/s | 120/150 W | 16 GB | No | Idem |
| 3 | CPU | 1 TFLOP/s | 120/150 W | 16 GB | No | Idem |
| 4 | FPGA | 5 TFLOP/s | 120/180 W | 16 GB | Yes | 1/Reconfiguration |
| | | | | | | latency 2/ |
| | | | | | | Performance on |
| | | | | | | Single Precision/ |
| | | | | | | Double Precision |
| | | | | | | 3/Memory |
| | | | | | | Bandwidth |
| 5 | GPU | 40 TFLOP/s | 450/600 W | 32 GB | Yes | 1/Performance on |
| | | | | | | Single Precision/ |
| | | | | | | Double Precision |
| | | | | | | Memory |
| | | | | | | Bandwidth 2/ |
| | | | | | | Shareable |
| 6 | Storage | 8 GB/s | 100/200 W | 100 GB | Yes | 1/Access latency |
| | | | | available | | 2/Bandwidth |

A valid indicator stored in persistent memory or storage can indicate whether compute elements table 228 is valid or has been invalidated. The valid indicator can be one bit (or word) and stored in persistent memory. For example, chassis intrusion detection 230 can indicate if a chassis or housing of network interface device 200 has been breached or intruded into, and can invalidate compute elements table 228 as contents of compute elements table 228 could have been tampered with or altered. Chassis intrusion detection 230 can identify when a resource of resources 240 might have been changed (e.g., added or removed) and invalidate table 228 by setting the valid indicator to invalid. Switch 212 can update table 228 upon next boot and table 228 can be set to valid.

Despite one or more of resources of resources 240 being powered-off or receiving reduced power and not being currently operational, switch 212 can provide a list for available resources to a requester of resource inventory. A boot up of network interface device 200 and periodically, switch 212 can update table 228 with current information.

While resources 240 are shown as part of network interface device 200, resources 240 can instead be located in a server or other platform accessible via a device interface (e.g., Peripheral Component Interconnect express (PCIe), Compute Express Link (CXL)) to communicate with network interface device 200. For example, network interface device 200 can communicate workloads, data, or memory or storage access requests to the server or other platform and receive workloads, data, or memory or storage access requests from the server or other platform.

For performance of an instruction to increase power allocated to one or more resources among resources 240, switch 212 can cause power balancing circuitry 226 to adapt power consumption to prescribed limits of devices of resources 240 and dynamically adapt power limits for one or more resource based on a power cap allocated to devices of network interface device 200. Switch 212 can query the power supply unit (PSU) for the highest available chassis power cap of network interface device 200.

Network interface device 200 can utilize a direct memory access (DMA) circuitry to copy data received from switch to one or more of resources 240 to copy the payload to be processed from a source platform or storage or memory device to memory to be processed by an instruction-specified resource.

Compute elements and accelerators of resources 240 can execute a micro-firmware (u-fw) to execute code to cause actual payload execution or data transfer requested by an instruction from switch 212. CPU sockets can include single or multiple compute elements. For multiple compute elements, the sockets (and their respective attached memory) can be booted independently. Switch 212 can interact with a basic input/output system (BIOS) (or a micro-firmware interacting with the BIOS) so an instruction-requested socket is booted and that socket becomes the bootstrap processor (BSP) which can perform the OS boot. Cores within the socket can become application processors (AP). With this approach, as many OSs as sockets could be run simultaneously.

In some examples, a Linux® Direct Rendering Manager (DRM) driver executed by a processor can control a general purpose GPU (GPGPU) or GPU. An application (e.g., microservice, virtual machine (VM), container) can utilize an API to interface with the DRM driver and submit commands to the DRM driver for execution by the GPGPU or GPU. To support remote GPU access, a DRM driver can control the GPGPU or GPU remotely (via network interface 210 and switch 212). In some examples, the DRM driver can execute in a micro-controller in resources 240 or in a processor network interface device 200 (e.g., one of processors 256). The DRM driver running in the micro-controller could wake-up and submit the workload to the GPGPU or GPGPU. A kernel module executing in network interface device 200 could act as a proxy for the remote GPU so that an application can request workload execution by providing instructions to a DRM driver.

For accelerator FPGAs, a processor-executed driver on network interface device 200 can control the accelerator and the submit jobs to the accelerator from switch 212.

HPC systems can be composed of multiple compute nodes that are orchestrated with a queue manager (e.g., Slurm, PBS, or others), and interconnected through a local area network (LAN). Edge nodes can be distributed and connected over a wide area network (WAN) and can be coordinated through multiple different transports (e.g., wireless, Multiprotocol Label Switching (MPLS), etc.). Nodes can have different compute elements, such as different numbers of CPU sockets, different memory capacity, different number and types of accelerators (e.g., FPGAs, GPUs, and GPGPUs). End users of an HPC or an edge infrastructure running on a node may need additional computational performance by use of accelerators in a different node.

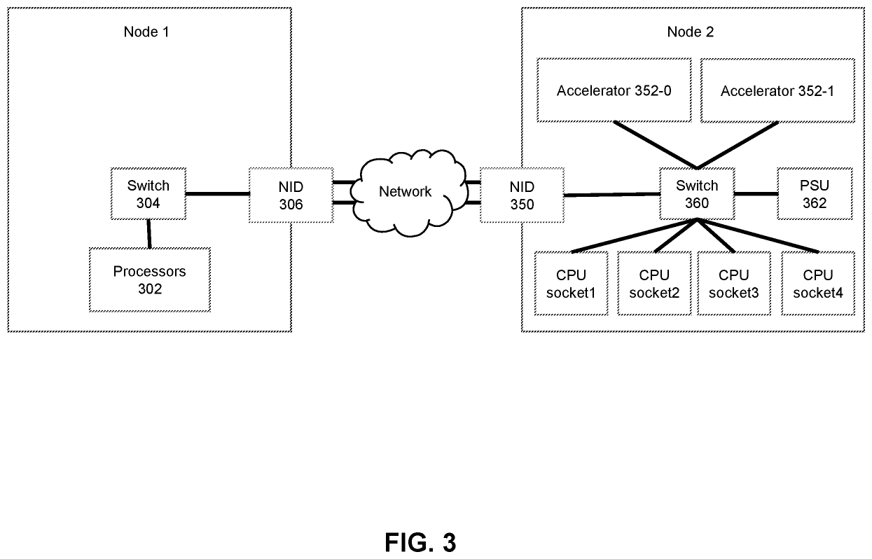

FIG. 3 depicts an example system. Node 1 can include processors 302 that executes one or more applications. An application can also refer to one or more of: VM, container, microservice, process, and so forth. In some examples, an application executed by processors 302 of Node 1 can request utilization of resources such as compute elements on Node 2. Compute elements can include independent memory or shared memory, GPUs, or accelerators. Although two nodes are shown, Node 1 can send workloads for execution by multiple nodes. For example, Node 1 can include switch 304 that can generate a computation requests from the application executed by processors 302 and cause the request to be transmitted to Node 2 through network interface device (NID) 306 via a fabric, network with one or more switches, an interconnect, device interface, or bus. An application executed by processors 302 can issue requests for resource inventory, request to power on a resource, and other requests described herein.

An application can employ accelerators for a fraction of the whole application execution lifetime. Instead of powering-on accelerators 352-0 and 352-1 and CPU sockets 1-4 continuously during an entire duration of the execution of application on Node 1, Node 2 can utilize WoC to power-on, execute and power-off specific resources on Node 2 that are used by the application executed on Node 1. Accordingly, energy consumption of Node 2 can be reduced. For example, if Node 2 is restricted to 1000 W, and an accelerator consumes up to 500 W in normal conditions, if only if one accelerator is powered on, the accelerator might enter in a turbo mode that could draw more than the 500 W and Node 2 can operate within its node power cap.

As described with at least with respect to FIG. 2, NID 350 and switch 360 can monitor network traffic for computation requests even if one or more or all resources on Node 2 are powered-off or are in low power mode. As described with at least with respect to FIG. 2, circuitry of switch 360 can be powered-on upon reception of specific computation requests or instructions from NID 350. As described with at least with respect to FIG. 2, switch 360 can forward the computation requests or instructions to a selected compute element.

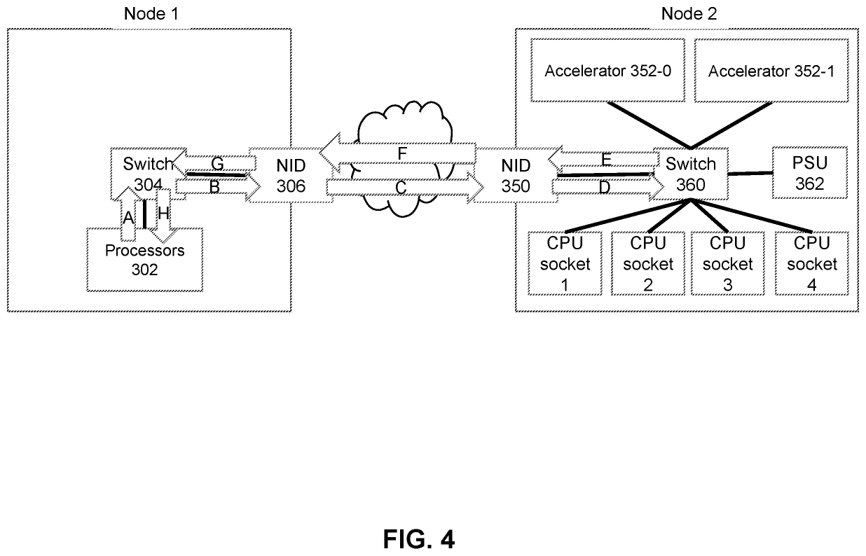

FIG. 4 depicts an example of operations for querying and/or discovering remote compute resources. The application running on processors 302 of Node 1 can request to discover available compute resources on Node 2 or search for a specific compute resource. At (A), the application can communicate with the switch on Node 1 to encode the request. At (B), the switch can generate at least one WoC packet with a query/discover request (e.g., operation (OP) code=1) and forward it to NID 306 of Node 1. At (C), NID 306 can send the message over the network to the remote node (Node 2). NID 350 of Node 2 can monitor for received packets and based on receipt of the packets, determine if the packets include a WoC packet. At (D), if NID 350 on Node 2 detects a WoC packet and discovers that Node 2 is powered-off, NID 350 can power-on switch 360. After powered-on, switch 360 could check against a list of acceptable MAC or IP addresses to determine if a requester of the inventory is an approved requester and the request can be processed. If the requester is approved, switch 360 can process the request and generate data of the available compute resources in Node 2. If the requester is not approved, the request can be discarded and an orchestrator or administrator notified of an attempt to access inventory from an unapproved requester.

At (E), switch 360 can generate a response (e.g., OP=2) and, if the list of compute resources is valid, encode the list in an auxiliary (AUX) field (described herein), and then provide the inventory to NID 350. Switch 360 can be powered off. At (F), NID 350 can send the message (or messages, depending on the list length) over the network to Node 1. At (G), NID 306 on Node 1 can provide the message to switch 304. At (H), switch 304 can receive the message and forward the results to the requestor application for processing. For example, the application can determine to or not to request utilization of a device on Node 2 based on whether the capabilities meet an applicable service level agreement (SLA) for a workload.

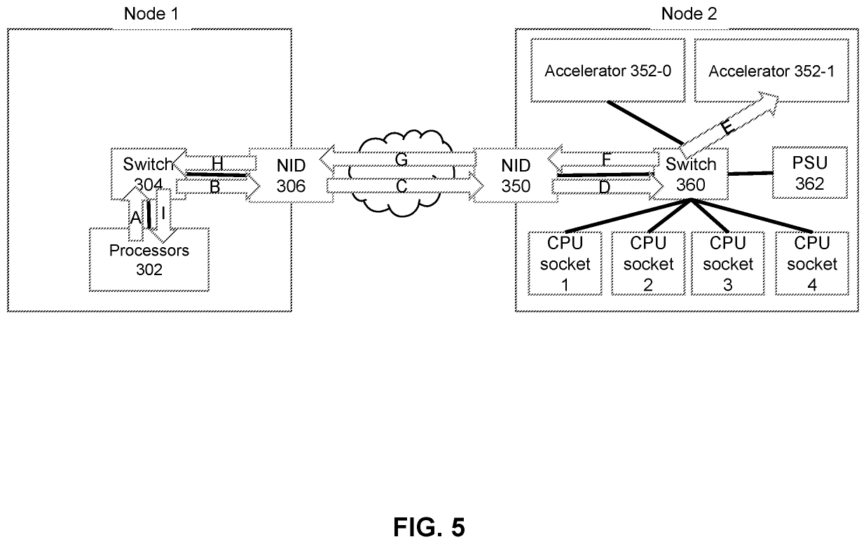

FIG. 5 depicts an example of operations for requesting a compute resource to execute a command (e.g., compute, memory transfer, or other commands such as power-on or power-off a resource). After an application has identified a compute resource on a remote node of its interest determined using the operations of FIG. 4, the application can request usage of the resource. At (A), the application executing on processors 302 of Node 1 request to utilize accelerator 352-1 of Node 2. The application can communicate with switch 304 to encode the request. At (B), switch 304 can generate a command request (e.g., OP=3) where the AUX field includes an accelerator ID for accelerator 352-1 (e.g., a universally unique identifier (UUID)). At (C), NID 306 can transmit the message in at least one packet over a network to Node 2.

At (D), NID 350 can identify that the at least one packet includes a WoC packet and can discover that Node 2 is powered-off. NID 350 can power-on switch 360. Switch 360 can initialize a power consumption table to note powering on the compute resource and control power limits to be within the chassis limits of Node 2. After powered-on, switch 360 can process the request from NID 350. Switch 360 can identify a request to utilize accelerator 352-1, which is powered-off, and switch 360 can communicate with PSU to power on accelerator 352-1 and accelerator 352-1 can boot up and execute a binary to perform a workload (e.g., encryption, decryption, image recognition, inference, compression, decompression, and so forth).

At (E), switch 360 can prepare a response message indicating whether accelerator 352-1 booted up properly (e.g., OP=4). Switch 360 can remain powered on until compute elements are powered-off. At (F), NID 350 on Node 2 can send the message over the network to Node 1. At (G), NID 306 on Node 1 can provide the message to switch 304.

At (H), switch 304 can provide the response message about the component availability and forward the result to the requestor application. A software stack executing on processors 302 can generate a handler to identify accelerator 352-1 on Node 2 for subsequent access.

Application executing on processors 302 can submit a workload (e.g., computation execution or data transfer) to accelerator 352-1 or other processor. The letter sequence (A) to (H) of FIG. 5 can be referenced for workload submission. At (A), the application running on processors 302 can issue a command to transfer data to accelerator 352-1 on Node 2. The application can communicate with switch 304 to encode the command. At (B), switch 304 can generate a payload request (e.g., OP=7) with the command and forward the command to NID 306. At (C), NID 306 can transmit the command in one or more packets over a network to Node 2. NID 350 can identify the one or more packets include a WoC packet and forward contents of the WoC packet to switch 360.

Switch 360 and accelerator 352-1 can be powered-on. Accelerator 352-1 can be powered-on due to a prior request to utilize the device. At (D), switch 360 can determine that the command is for payload execution (e.g., code execution, or data transfer). For additional incoming code or data, switch 360 can establish an additional connection between NID 306 and NID 350 to receive that code or data. At (E), switch 360 can submit the payload execution to the requested compute element (e.g., accelerator 352-1). At (F), if there is an output data transfer because of the payload, switch 360 can establishes an additional connection with the sender to send the result.

At (G), NID 350 can send a message over the network using UDP or TCP/IP to NID 306 with a response of data or status (e.g., operation succeeded or failed). At (H), NID 306 can provide the response to switch 304. At (I), switch 304 can forward (and potentially decrypt) the received response to the requesting application.

Applications using remote compute resources handled by WoC could power-off the powered-on resources following the letter sequence (A) to (H) of FIG. 5 but with different operations. At (A), the application running on processors 302 of Node 1 is to discontinue to use accelerator 352-1 on Node 2 and communicate it through the determined handler previously. At (B), switch 304 can generate a power-off request (e.g., OP=5) and forwards it to NID 306. At (C), NID 306 can transmit the request over the network in one or more packets to Node).

At (D), NID 350 on Node 2 can receive the request and identify a WoC packet. NID 350 can provide the request to switch 360 (powered-on). At (E), switch 360 can communicate with accelerator 352-1 the request to power-off accelerator 352-1. When an indication that accelerator 352-1 is powered-off, switch 360 can communicate with PSU 362 to remove the power to accelerator 352-1. Switch 360 can send a return message to NID 306 indicating accelerator 352-1 is powered off. If compute elements of Node 2 are powered off, switch 360 can be powered off as well. If there are one or more compute elements or resources still powered on, switch 360 can update the power consumption table and adapt power distribution to active compute elements and opportunistic compute or power needs. At (F), NID 350 can transmit a power-off message completion (e.g., OP=6) over the network to NID 306 of Node 1.

At (G), NID 306 of Node 1 can provide the result to switch 304. At (H), switch 304 can potentially decrypt the result and forward the result to the requestor application. The handler for accelerator 352-1 can be disabled and marked as invalid in the software stack for switch 304.

In some cases, applications may fail to power-off resources when resources are no longer to be utilized. In some examples, resources of Node 2 can be powered-off after a time of inactivity. For example, switch 360 can identify inactivity of one or more resources and cause the one or more inactive resources to power-off.

Integration of WoC nodes into HPC batch job schedulers, such as SLURM, can be supported. A batch job scheduler can identify available resources and the perform the allocation of those resources before a job request is sent. Depending on the settings and the request being made, a remote node infrastructure such as CPU may be powered up at job allocation. Remote nodes can remain in power save mode unless woken up through WoC. Local nodes that execute applications, which can utilize resources of remote nodes, can be powered on.

Resources described in a batch job queue system configuration can be allocated as exclusive. At job allocation time, a batch job scheduler can reserve a requested amount of WoC nodes and prevent other jobs running simultaneously from accessing resources of the WoC nodes.

WoC resources can overcommitted shared resources. A batch job queue system configuration can access shared resources from a pool, with an option that one or more resources is overcommitted. At job allocation time, the batch job scheduler can reserve a requested amount of WoC nodes such that their resources may be shared between simultaneously running jobs, but within the predefined overcommit constraints.

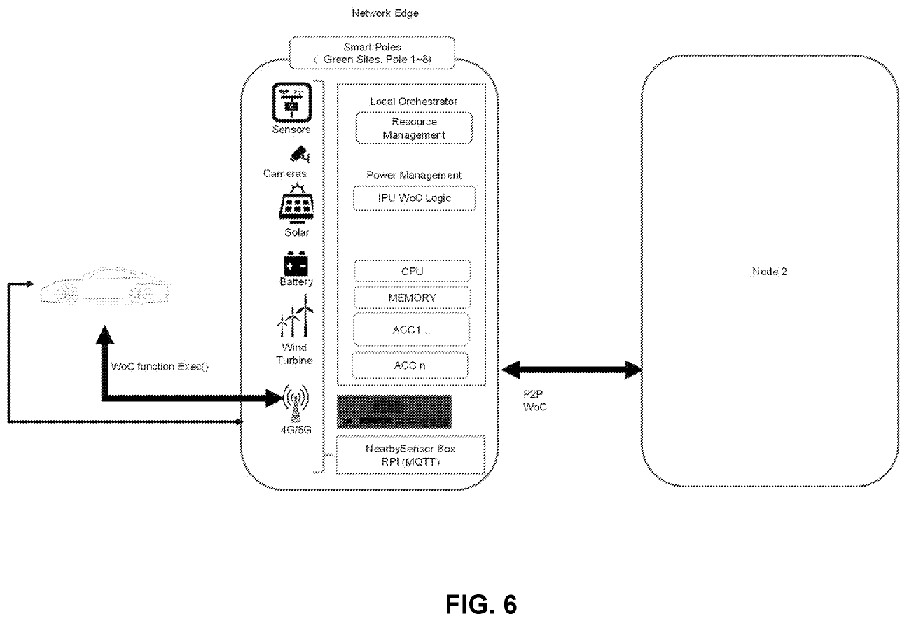

FIG. 6 depicts an example of edge deployments where multiple devices or end users (such as vehicles) may request base stations or edge appliances to perform the execution of operations. A wireless or radio access network (RAN) devices could be connected into a network interface device and transmit WoC requests. At least one of the RAN devices can be connected to a Power over Ethernet (PoE) switch and a platform via a network interface device. A potential series of operations could be as follows. At (1), a device can send an encapsulated WoC request to the network edge via 4G or 5G protocol or other wireless protocols. At (2), request can be routed via local switch into a network interface device (IPU). At (3), network interface device may have telemetry from other base stations nearby indicating the availability of compute and status of the devices. At (4), network interface device may determine to execute a workload locally on a resource connected to the network edge. At (5), network interface device may determine to forward the request to a peer base station or edge appliance (e.g., Node 2). At (6), forwarding of the request can be performed via 4G, 5G, or other protocol. At (7), the target network interface device and switch can perform operations such as resource inventory identification, resource power-on request, resource utilization request, resource power-off request, or others.

### Proposed Extension to the WOL Protocol for Wake-on-Compute (WOC)

WoL protocol is described at least in Energy Efficient Ethernet (EEE) IEEE 802.3az (2010). WoL can be implemented using a network frame called a magic packet that is sent to computers in a network. A compute node to be awakened can maintain its NIC powered-on but running at the slowest speed to save power. The magic packet can include 6 0xff bytes followed by 16 repetitions of the target computer's 48-bit MAC address (for a total of 102 bytes). Such magic packet can be typically transmitted using an UDP protocol to avoid establishing an active connection.

In some examples, a magic packet for the WoC protocol can be as follows. One repetition of the target computer's MAC address can be used to identify a target computer and identify a WoC packet. In some examples, up to 14×48 bits (72 bytes) can be used for encoding additional data. For example, a WoC packet can include 7 fields.

| | | Logical not | | | | |
|---|---|---|---|---|---|---|
| | | of target’s | | | | |
| | target’s | MAC | source’s | source’s | | |
| ff ff ff ff | MAC | address | MAC | IPv6 | OP | Aux |
| 6 bytes | 6 bytes | 6 bytes | 6 bytes | 16 bytes | 8 bytes | 48 bytes |

1) WoL, 6 0xff bytes
2) 1 repetition (rather than 14) of the target's MAC address
3) Logical MAC address
4) 1 repetition of the source's MAC address
5) 1 repetition of the source's IPv6 (or IPv4) address
6) 8 bytes for encoding an operation
7) 48 bytes for encoding any auxiliary/operands for the operation

A target network interface device can check if fields 2 and 3 are the negative of the other, which identify a WoC packet. Fields 4 and 5 can be included at least to provide connection details for payload transfer, and for denial-of-services avoidance or mitigations through permitted lists.

Field 6 can refer to operations (e.g., query/discovery, allocate compute resource, payload execution request, free compute resource, power up, power down, etc.) to be performed by a remote node. The following are an example of operations.

| OP code | Operation |
|---|---|
| 1 | Query/Discover request |
| 2 | Query/Discover response |
| 3 | Allocate/Power-on request |
| 4 | Allocate/Power-on response |
| 5 | Deallocate/Power-off request |
| 6 | Deallocate/Power-off response |
| 7 | Payload execution request |
| 8 | Payload execution response |
| . . . | Reserved for future uses |

Field 7 can refer to auxiliary data or operand for OP (field 6). For instance, Field 7 can indicate a specific type of compute elements to be discovered through OP=1 or specify the specific UUID for the allocation or power-on of a specific compute resource.

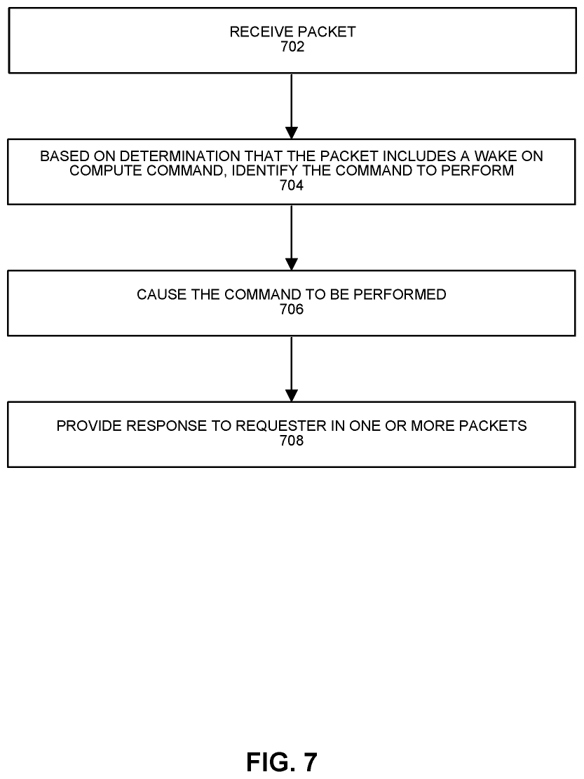

FIG. 7 depicts an example process. The process can be performed by a switch in a network interface device. At 702, the network interface device can receive a packet. At 704, based on the network interface device identifying a wake on compute (WoC) command in the packet, the switch can parse the command and determine the command to perform. For example, the command can request device or hardware capabilities of the network interface device or device or hardware capabilities connected to the network interface device. For example, the command can request the network interface device to cause an instruction-specified device or hardware to perform a workload to process data or store or retrieve data. For example, the command can request the network interface device to cause an instruction-specified device or hardware to reduce power consumption or increase power consumption. At 706, the switch can cause the command to be performed. For example, the command can cause an identification of available resources to be provided, as described herein. For example, the command can cause a resource to be powered-on or powered-off, as described herein. At 708, the network interface device can cause a response to the command to be provided to a sender of the WoC command. For example, the response can indicate an inventory of resources, indication a resource was powered-on or powered-off, or others.

FIG. 8 depicts an example network interface device. In some examples, processors 904 and/or FPGAs 840 can be configured to perform identification of requests from a remote node, as described herein. Some examples of network interface 800 are part of an Infrastructure Processing Unit (IPU) or data processing unit (DPU) or utilized by an IPU or DPU. An XPU or xPU can refer at least to an IPU, DPU, graphics processing unit (GPU), general purpose GPU (GPGPU), or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 800 can include transceiver 802, processors 804, transmit queue 806, receive queue 808, memory 810, and bus interface 812, and DMA engine 852. Transceiver 802 can be capable of receiving and transmitting packets in conformance with the applicable protocols such as Ethernet as described in IEEE 802.3, although other protocols may be used. Transceiver 802 can receive and transmit packets from and to a network via a network medium (not depicted). Transceiver 802 can include PHY circuitry 814 and media access control (MAC) circuitry 816. PHY circuitry 814 can include encoding and decoding circuitry (not shown) to encode and decode data packets according to applicable physical layer specifications or standards. MAC circuitry 816 can be configured to perform MAC address filtering on received packets, process MAC headers of received packets by verifying data integrity, remove preambles and padding, and provide packet content for processing by higher layers. MAC circuitry 816 can be configured to assemble data to be transmitted into packets, that include destination and source addresses along with network control information and error detection hash values.

Processors 804 can be one or more of: combination of: a processor, core, graphics processing unit (GPU), field programmable gate array (FPGA), application specific integrated circuit (ASIC), or other programmable hardware device that allow programming of network interface 800. For example, a “smart network interface” or SmartNIC can provide packet processing capabilities in the network interface using processors 804.

Processors 804 can include a programmable processing pipeline that is programmable by Programming Protocol-independent Packet Processors (P4), Software for Open Networking in the Cloud (SONiC), C, Python, Broadcom Network Programming Language (NPL), NVIDIA® CUDA®, NVIDIA® DOCA™, Infrastructure Programmer Development Kit (IPDK), or x86 compatible executable binaries or other executable binaries. A programmable processing pipeline can include one or more match-action units (MAUs) that can schedule packets for transmission using one or multiple granularity lists, as described herein. Processors, FPGAs, other specialized processors, controllers, devices, and/or circuits can be used utilized for packet processing or packet modification. Ternary content-addressable memory (TCAM) can be used for parallel match-action or look-up operations on packet header content. Processors 804 and/or FPGAs 840 can be configured to perform event detection and action.

Packet allocator 824 can provide distribution of received packets for processing by multiple CPUs or cores using receive side scaling (RSS). When packet allocator 824 uses RSS, packet allocator 824 can calculate a hash or make another determination based on contents of a received packet to determine which CPU or core is to process a packet.

Interrupt coalesce 822 can perform interrupt moderation whereby network interface interrupt coalesce 822 waits for multiple packets to arrive, or for a time-out to expire, before generating an interrupt to host system to process received packet(s). Receive Segment Coalescing (RSC) can be performed by network interface 800 whereby portions of incoming packets are combined into segments of a packet. Network interface 800 provides this coalesced packet to an application.

Direct memory access (DMA) engine 852 can copy a packet header, packet payload, and/or descriptor directly from host memory to the network interface or vice versa, instead of copying the packet to an intermediate buffer at the host and then using another copy operation from the intermediate buffer to the destination buffer.

Memory 810 can be any type of volatile or non-volatile memory device and can store any queue or instructions used to program network interface 800. Transmit traffic manager can schedule transmission of packets from transmit queue 806. Transmit queue 806 can include data or references to data for transmission by network interface. Receive queue 808 can include data or references to data that was received by network interface from a network. Descriptor queues 820 can include descriptors that reference data or packets in transmit queue 806 or receive queue 808. Bus interface 812 can provide an interface with host device (not depicted). For example, bus interface 812 can be compatible with or based at least in part on PCI, PCIe, PCI-x, Serial ATA, and/or USB (although other interconnection standards may be used), or proprietary variations thereof.

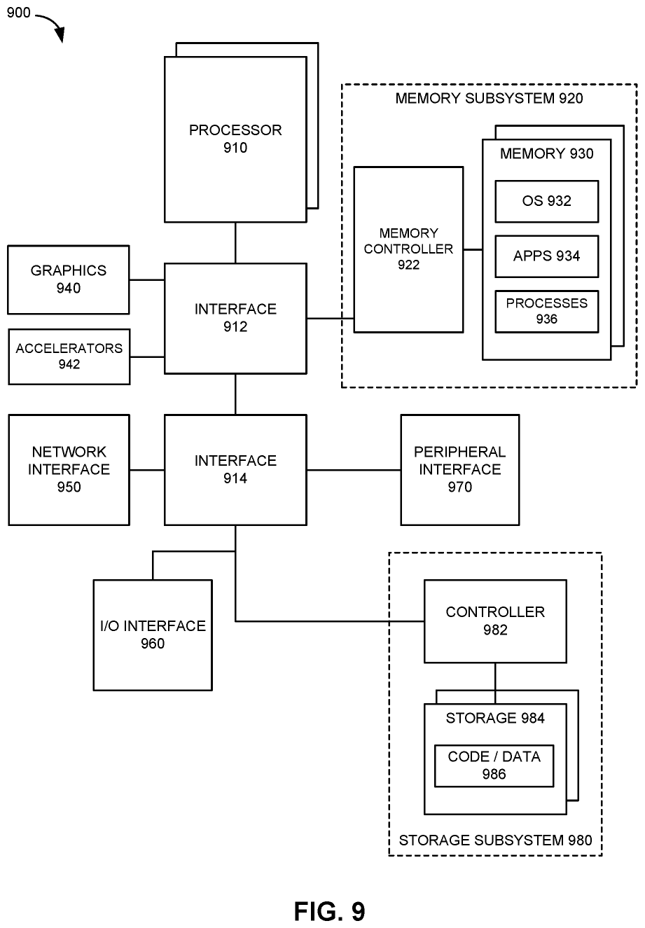

FIG. 9 depicts an example system. Components of system 900 (e.g., processor 910, graphics 940, accelerators 942, memory 930, storage 984, network interface 950, and so forth) can be utilized in a Node 1 or Node 2 as described herein. System 900 includes processor 910, which provides processing, operation management, and execution of instructions for system 900. Processor 910 can include any type of microprocessor, central processing unit (CPU), graphics processing unit (GPU), processing core, or other processing hardware to provide processing for system 900, or a combination of processors. Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die. Where present, graphics interface 940 interfaces to graphics components for providing a visual display to a user of system 900. In one example, graphics interface 940 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 940 generates a display based on data stored in memory 930 or based on operations executed by processor 910 or both. In one example, graphics interface 940 generates a display based on data stored in memory 930 or based on operations executed by processor 910 or both.

Accelerators 942 can be a fixed function or programmable offload engine that can be accessed or used by a processor 910. For example, an accelerator among accelerators 942 can provide compression (DC) capability, cryptography services such as public key encryption (PKE), cipher, hash/authentication capabilities, decryption, or other capabilities or services. In some embodiments, in addition or alternatively, an accelerator among accelerators 942 provides field select controller capabilities as described herein. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 942 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as DRAM, or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory.

In some examples, network interface device 950 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance. Some examples of network interface 950 are part of an Infrastructure Processing Unit (IPU) or data processing unit (DPU) or utilized by an IPU or DPU. An XPU or xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. A programmable pipeline can be programmed using one or more of: P4, SONiC, C, Python, Broadcom Network Programming Language (NPL), NVIDIA® CUDA®, NVIDIA® DOCA™, Infrastructure Programmer Development Kit (IPDK), or x86 compatible executable binaries or other executable binaries.

In one example, system 900 includes one or more input/output (I/O) interface(s) 960. I/O interface 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

A volatile memory is memory whose state (and therefore the data stored in it) is indeterminate if power is interrupted to the device. Dynamic volatile memory uses refreshing the data stored in the device to maintain state. One example of dynamic volatile memory incudes DRAM (Dynamic Random Access Memory), or some variant such as Synchronous DRAM (SDRAM). An example of a volatile memory include a cache. A memory subsystem as described herein may be compatible with a number of memory technologies, such as those consistent with specifications from JEDEC (Joint Electronic Device Engineering Council) or others or combinations of memory technologies, and technologies based on derivatives or extensions of such specifications.

A non-volatile memory (NVM) device is a memory whose state is determinate even if power is interrupted to the device. In one embodiment, the NVM device can comprise a block addressable memory device, such as NAND technologies, or more specifically, multi-threshold level NAND flash memory (for example, Single-Level Cell (“SLC”), Multi-Level Cell (“MLC”), Quad-Level Cell (“QLC”), Tri-Level Cell (“TLC”), or some other NAND). A NVM device can also comprise a byte-addressable write-in-place three dimensional cross point memory device, or other byte addressable write-in-place NVM device (also referred to as persistent memory), such as single or multi-level Phase Change Memory (PCM) or phase change memory with a switch (PCMS), Intel® Optane™ memory, NVM devices that use chalcogenide phase change material (for example, chalcogenide glass), a combination of one or more of the above, or other memory.

A power source (not depicted) provides power to the components of system 900. More specifically, power source typically interfaces to one or multiple power supplies in system 900 to provide power to the components of system 900. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 900 can be implemented using interconnected compute sleds of processors, memories, storages, network interfaces, and other components. High speed interconnects or device interfaces can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), Universal Chiplet Interconnect Express (UCIe), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., Non-Volatile Memory Express (NVMe) Specification, revision 1.3c, published on May 24, 2018 or earlier or later versions, or revisions thereof).

Communications between devices can take place using a network that provides die-to-die communications; chip-to-chip communications; circuit board-to-circuit board communications; and/or package-to-package communications.

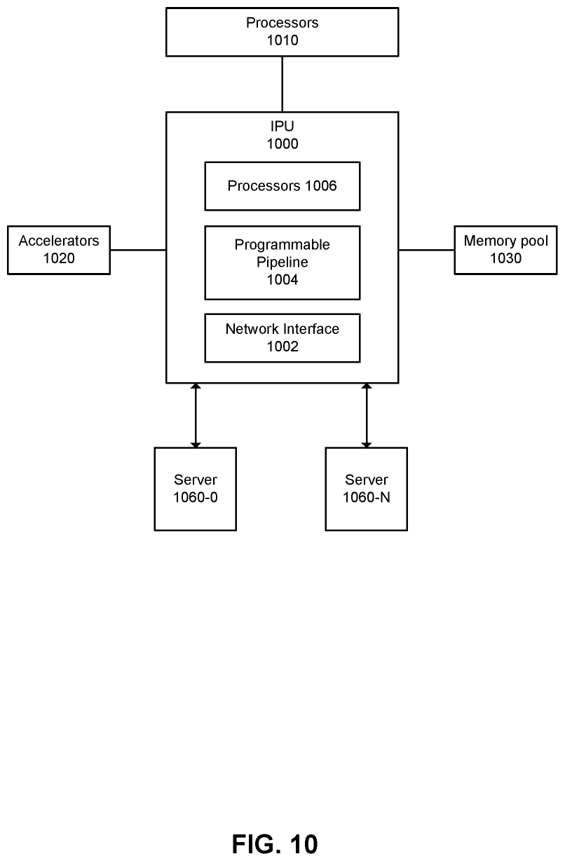

FIG. 10 depicts an example system. In this system, IPU 1000 manages performance of one or more processes using one or more of processors 1006, processors 1010, accelerators 1020, memory pool 1030, or servers 1040-0 to 1040-N, where N is an integer of 1 or more. In some examples, processors 1006 of IPU 1000 can execute one or more processes, applications, VMs, containers, microservices, and so forth that request performance of workloads by one or more of: processors 1010, accelerators 1020, memory pool 1030, and/or servers 1040-0 to 1040-N. IPU 1000 can utilize network interface 1002 or one or more device interfaces to communicate with processors 1010, accelerators 1020, memory pool 1030, and/or servers 1040-0 to 1040-N. IPU 1000 can utilize programmable pipeline 1004 to process packets that are to be transmitted from network interface 1002 or packets received from network interface 1002. Programmable pipeline 1004 and/or processors 1006 can be configured to perform routing of data to an accelerator or XPU and routing of control signals to a SoC as well as removal of data from a packet or insertion of data into a packet, as described herein.

Embodiments herein may be implemented in various types of computing, smart phones, tablets, personal computers, and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, each blade includes components common to conventional servers, including a main printed circuit board (main board) providing internal wiring (e.g., buses) for coupling appropriate integrated circuits (ICs) and other components mounted to the board.

In some examples, network interface and other embodiments described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), micro data center, on-premise data centers, off-premise data centers, edge network elements, fog network elements, and/or hybrid data centers (e.g., data center that use virtualization, serverless computing systems (e.g., Amazon Web Services (AWS) Lambda), content delivery networks (CDN), cloud and software-defined networking to deliver application workloads across physical data centers and distributed multi-cloud environments).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”′

Illustrative examples of the devices, systems, and methods disclosed herein are provided below. An embodiment of the devices, systems, and methods may include any one or more, and any combination of, the examples described below.

Example 1 includes one or more examples, and includes an apparatus comprising: a network interface device comprising: circuitry to perform switching and perform a received command in one or more packets while at least one of at least one compute device is in a reduced power state, wherein the command is associated with operation of the at least one of the at least one compute device that is in a reduced power state. In some examples, the at least one compute device is part of the network interface device and within a same chassis, whereas in some examples, the at least one compute is in a different chassis than that of the network interface device and connected to the network interface device through a device interface or network.

Example 2 includes one or more examples, wherein the at least one compute device comprises one or more of: an accelerator, graphics processing unit (GPU), central processing unit (CPU), storage, or memory.

Example 3 includes one or more examples, wherein the circuitry to perform switching is to perform switching based at least on: Peripheral Component Interconnect Express (PCIe), Compute Express Link (CXL), or Universal Chiplet Interconnect Express (UCIe).

Example 4 includes one or more examples, wherein the one or more packets comprise a Wake-on-LAN (WoL) magic packet.

Example 5 includes one or more examples, wherein the command is to request capabilities of the at least one compute device.

Example 6 includes one or more examples, wherein the command is to request power-on of a particular compute device and performance of a workload.

Example 7 includes one or more examples, wherein the command is to request power-off of a particular compute device.

Example 8 includes one or more examples, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Example 9 includes one or more examples, comprising at least one power rail to provide power to the at least one compute device to provide power to one of the at least one compute device independent of power to a second of the at least one compute device.

Example 10 includes one or more examples, and includes a non-transitory computer-readable medium comprising instructions stored thereon, that if executed by one or more processors, cause the one or more processors to: configure a network interface device comprising at least one compute device and circuitry to perform switching to perform a received command in one or more packets while at least one of the at least one compute device is in a reduced power state, wherein the command is associated with operation of the at least one of the at least one compute device that is in a reduced power state.

Example 11 includes one or more examples, wherein the at least one compute device comprises one or more of: an accelerator, graphics processing unit (GPU), central processing unit (CPU), storage, or memory.

Example 12 includes one or more examples, wherein the circuitry to perform switching is to perform switching based at least on: Peripheral Component Interconnect Express (PCIe), Compute Express Link (CXL), or Universal Chiplet Interconnect Express (UCIe).

Example 13 includes one or more examples, wherein the one or more packets comprise a Wake-on-LAN (WoL) magic packet.

Example 14 includes one or more examples, wherein the command is to request capabilities of the at least one compute device.

Example 15 includes one or more examples, wherein the command is to request power-on of a particular compute device and performance of a workload.

Example 16 includes one or more examples, wherein the command is to request power-off of a particular compute device.

Example 17 includes one or more examples, and includes a method comprising: in a network interface device: performing a received command in one or more packets while at least one compute device controlled by the network interface device is in a reduced power state, wherein the command is associated with operation of the at least one of the at least one compute device that is in a reduced power state.

Example 18 includes one or more examples, wherein the one or more packets comprise a Wake-on-LAN (WoL) magic packet.

Example 19 includes one or more examples, wherein the command is to request capabilities of the at least one compute device.

Example 20 includes one or more examples, wherein the command is to request power-on of a particular compute device and performance of a workload.

Example 21 includes one or more examples, wherein the command is to request power-off of a particular compute device.

What is claimed is:

1. An apparatus comprising:
a network interface device comprising:
at least one compute device and
circuitry to perform switching and perform a received command in one or more packets while at least one of the at least one compute device is in a reduced power state, wherein the command is associated with operation of the at least one of the at least one compute device that is in a reduced power state.

2. The apparatus of claim 1, wherein the at least one compute device comprises one or more of: an accelerator, graphics processing unit (GPU), central processing unit (CPU), storage, or memory.

3. The apparatus of claim 1, wherein the circuitry to perform switching is to perform switching based at least on: Peripheral Component Interconnect Express (PCIe), Compute Express Link (CXL), or Universal Chiplet Interconnect Express (UCIe).

4. The apparatus of claim 1, wherein the one or more packets comprise a Wake-on-LAN (WoL) magic packet.

5. The apparatus of claim 1, wherein the command is to request capabilities of the at least one compute device.

6. The apparatus of claim 1, wherein the command is to request power-on of a particular compute device and performance of a workload.

7. The apparatus of claim 1, wherein the command is to request power-off of a particular compute device.

8. The apparatus of claim 1, wherein the network interface device comprises one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

9. The apparatus of claim 1, comprising at least one power rail to provide power to the at least one compute device to provide power to one of the at least one compute device independent of power to a second of the at least one compute device.

10. A non-transitory computer-readable medium comprising instructions stored thereon, that if executed by one or more processors, cause the one or more processors to:
configure a network interface device comprising at least one compute device and circuitry to perform switching to perform a received command in one or more packets while at least one of the at least one compute device is in a reduced power state, wherein the command is associated with operation of the at least one of the at least one compute device that is in a reduced power state.

11. The non-transitory computer-readable medium of claim 10, wherein the at least one compute device comprises one or more of: an accelerator, graphics processing unit (GPU), central processing unit (CPU), storage, or memory.

12. The non-transitory computer-readable medium of claim 10, wherein the circuitry to perform switching is to perform switching based at least on: Peripheral Component Interconnect Express (PCIe), Compute Express Link (CXL), or Universal Chiplet Interconnect Express (UCIe).

13. The non-transitory computer-readable medium of claim 10, wherein the one or more packets comprise a Wake-on-LAN (WoL) magic packet.

14. The non-transitory computer-readable medium of claim 10, wherein the command is to request capabilities of the at least one compute device.

15. The non-transitory computer-readable medium of claim 10, wherein the command is to request power-on of a particular compute device and performance of a workload.

16. The non-transitory computer-readable medium of claim 10, wherein the command is to request power-off of a particular compute device.

17. A method comprising:
in a network interface device:
performing a received command in one or more packets while at least one compute device controlled by the network interface device is in a reduced power state, wherein the command is associated with operation of the at least one of the at least one compute device that is in a reduced power state.

18. The method of claim 17, wherein the one or more packets comprise a Wake-on-LAN (WoL) magic packet.

19. The method of claim 17, wherein the command is to request capabilities of the at least one compute device.

20. The method of claim 17, wherein the command is to request power-on of a particular compute device and performance of a workload.

21. The method of claim 17, wherein the command is to request power-off of a particular compute device.
